(19) United States
(12) Patent Application Publication
(10) Pub. No.: US 2005/0099360 A1
(43) Pub. Date: May 12, 2005

(54) Combinational portable electronic device

(76) Inventor: Wen Hsiang Yueh, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,577

(22) Filed: Nov. 12, 2003

(51) Int. Cl. G09G 5/00

(52) U.S. Cl. 345/1.1

(57) ABSTRACT

A combinational portable electronic device has a first electronic device having a display panel and a second electronic device having also a display panel. The first electronic device has an accommodating groove with a first connection interface provided therein. The second electronic device has a second connection interface. The second electronic device is installed in the accommodating groove of the first electronic device with the first connection interface and the second connection interface electrically connected together. When a function operation of the second electronic device (e.g., a PDA) is performed, the displayed frame data can be sent to the first electronic device (e.g., an electronic book reader or a web-pad) for display.

### FIELD OF THE INVENTION

The present invention relates to a combinational portable electronic device and, more particularly, to a portable electronic device integrating an electronic book reader (or a web-pad) and a personal digital assistant (PDA) to let the combined device have powerful functions of the PDA and a large screen of the electronic book reader for display.

### BACKGROUND OF THE INVENTION

Conventional books are bulky and heavy, and can't be stored for a long time. Therefore, the electronic book has emerged. The contents of an electronic book are stored in an electronic book reader. As shown in FIG. 1, when an electronic book reader is used to read an electronic book, the contents of the electronic book are displayed one page after another. An electronic book reader is mainly used for reading electronic books, and has a large display panel for clear reading. Other extra functions are not a stressed point of electronic book reader.

On the other hand, the best candidate of existent portable devices is the powerful personal digital assistant (PDA). As shown in FIG. 2, a PDA has many functions like simple text editing, business card management, personal calendar, notepad, telephone book, games and entertainments, multimedia audio/video playback and other operation functions provided by various application softwares. Because the PDA is conveniently portable and has powerful functions, it is in great demand. However, a PDA is usually compact, hence limiting the size of its display panel. Users may be not able to see clearly the displayed contents due to a too small size of the display panel, hence resulting in inconvenience in its operation.

If the display panel of an electronic book reader (or another electronic device having a large display panel) and the powerful functions of a PDA can be integrated together, a portable device having both a large display panel and powerful functions can be obtained.

### SUMMARY AND OBJECTS OF THE PRESENT INVENTION

The primary object of the present invention is to provide a combinational portable electronic device, which integrates a PDA having powerful functions and an electronic book reader (or a web-pad) having a large display panel together via connection interfaces. Functions originally executed by the PDA can send the displayed frame data to the electronic book reader for display via the connection interfaces.

To achieve the above object, the present invention mainly provides a combinational portable electronic device, which comprises a first electronic device having a display panel and a second electronic device having also a display panel. The first electronic device has an accommodating groove with a first connection interface provided therein. The second electronic device has a second connection interface. The second electronic device is arranged in the accommodating groove of the first electronic device with the first connection interface and the second connection interface electrically connected together so that the first electronic device and the second electronic device can transmit data to each other.

### BRIEF DESCRIPTION OF THE DRAWING

The various objects and advantages of the present invention will be more readily understood from the following detailed description when read in conjunction with the appended drawings, in which:

FIG. 1 is a diagram of a conventional electronic book reader;

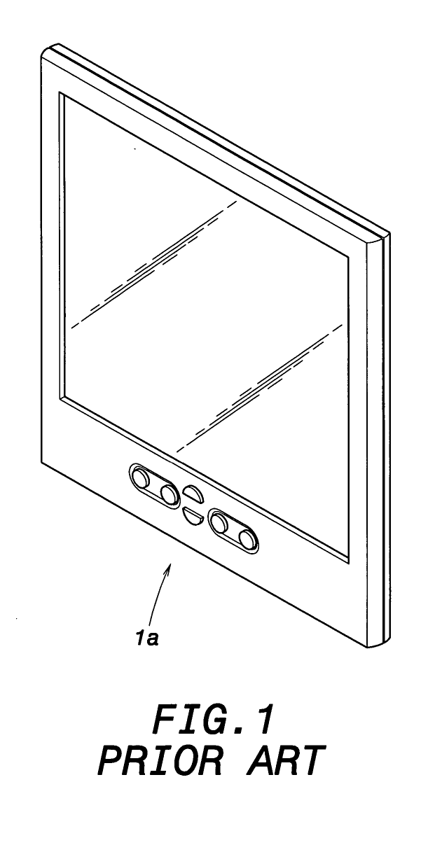

FIG. 2 is a diagram of a conventional personal digital assistant;

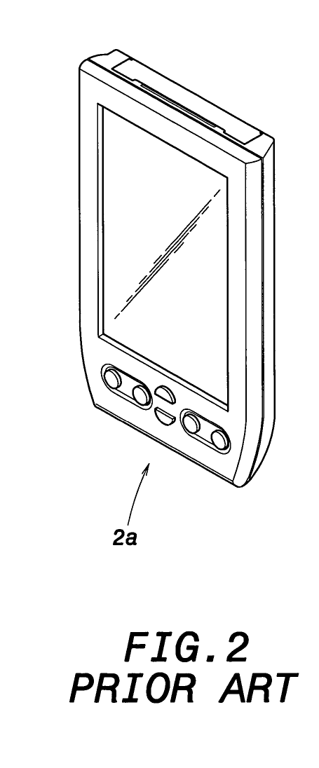

FIG. 3 is an exploded perspective view of a first electronic device and a second electronic device of the present invention;

FIG. 4 is a back view of a first electronic device of the present invention;

FIG. 5 is a first action diagram showing a cover board closing an accommodating groove of a first electronic device of the present invention;

FIG. 6 is a second action diagram showing a cover board closing an accommodating groove of a first electronic device of the present invention; and

FIG. 7 is an assembly diagram of a first electronic device and a second electronic device of the present invention.

### DETAILED DESCRIPTION OF THE PREFERRED EMBODIMENT

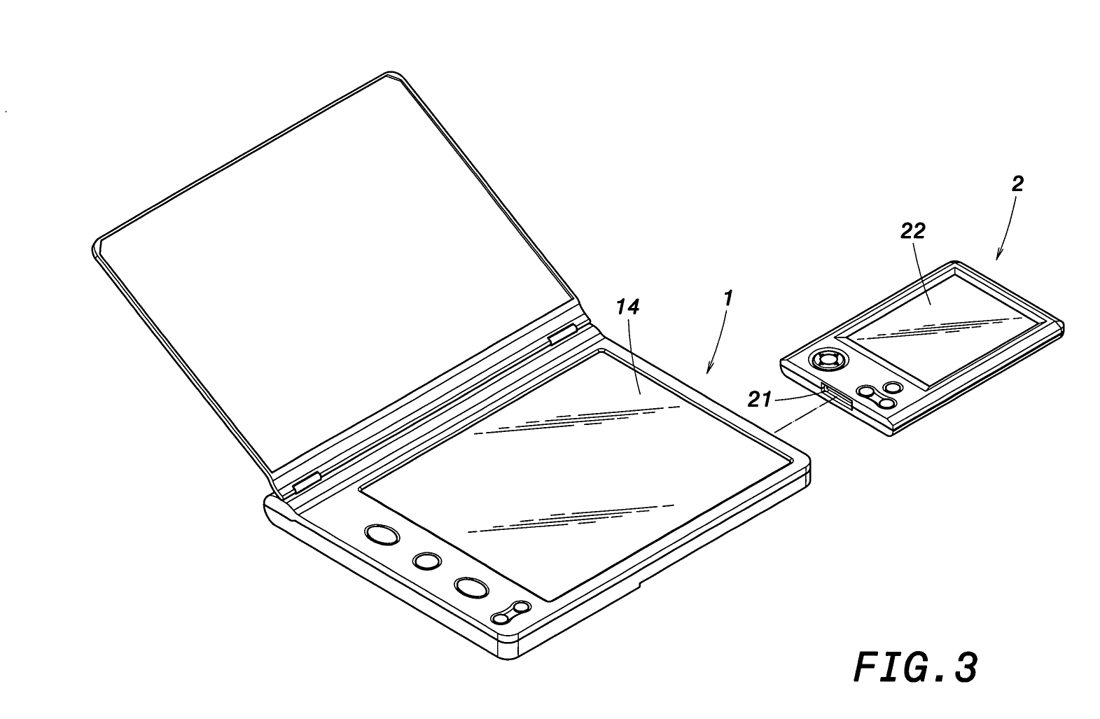

As shown in FIG. 3, a combinational portable electronic device of the present invention is formed by connecting a first electronic device 1 and a second electronic device 2. Frames originally displayed on a display panel of the second electronic device 2 can be transmitted to a display panel 14 of the first electronic device 1 for displaying. The size of the display panel 14 of the first electronic device 1 is larger than that of the display panel 22 of the second electronic device 2. The above first electronic device 1 is an electronic book reader, a web-pad, or another electronic device having a large display panel. For convenient illustration, the first electronic device 1 is exemplified with an electronic book reader below. The above second electronic device 2 is a personal digital assistant (PDA) having powerful functions. The second electronic device 2 has a second connection interface 21 for data transmission.

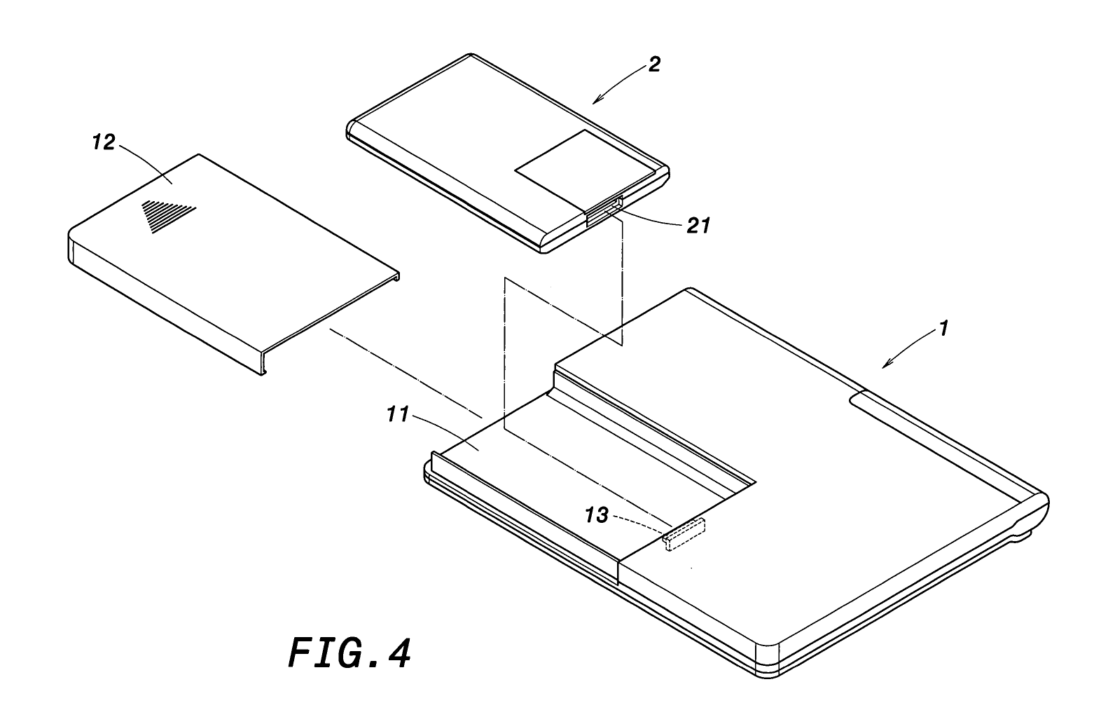

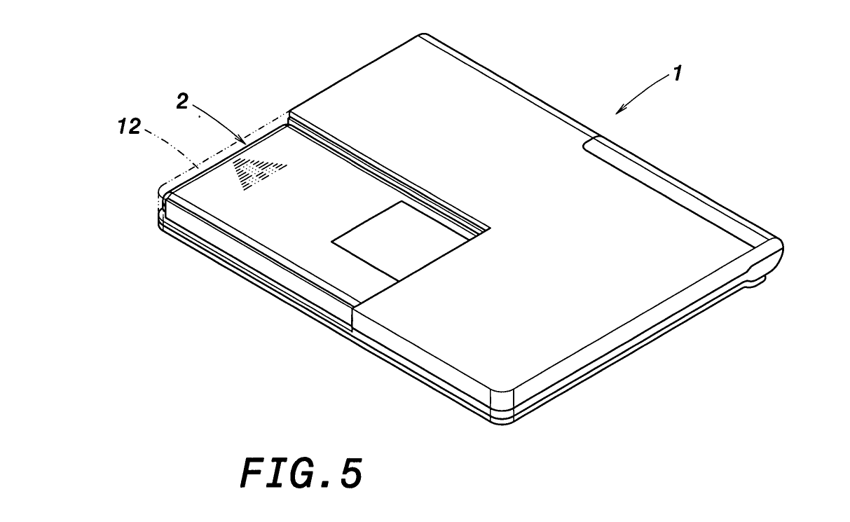

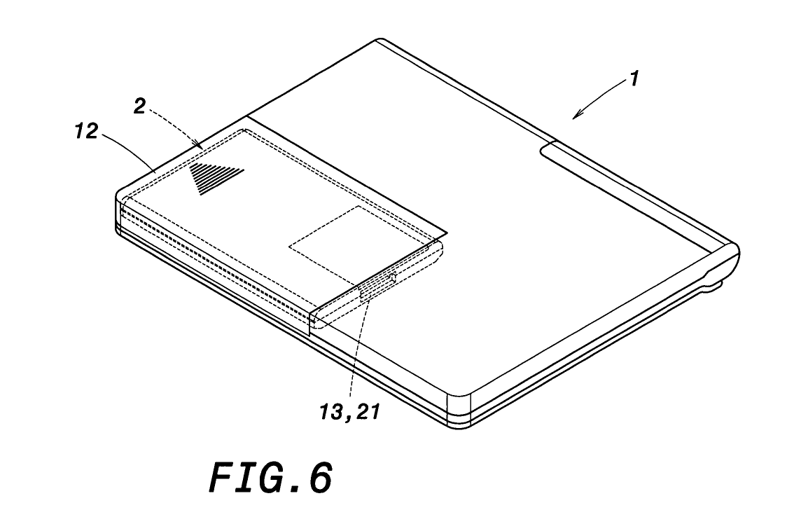

As shown in FIGS. 4 to 6, an accommodating groove 11 is formed in the back face of the first electronic device 1 for accommodating the second electronic device 2. A first connection interface 13 is provided in the accommodating groove 11 for electric connection with a second connection interface 21 of the second electronic device 2. The accommodating groove 11 has a cover board 12 outside. The cover board 12 is used to close the accommodating groove to prevent the second electronic device 2 arranged in the accommodating groove 11 from dropping off.

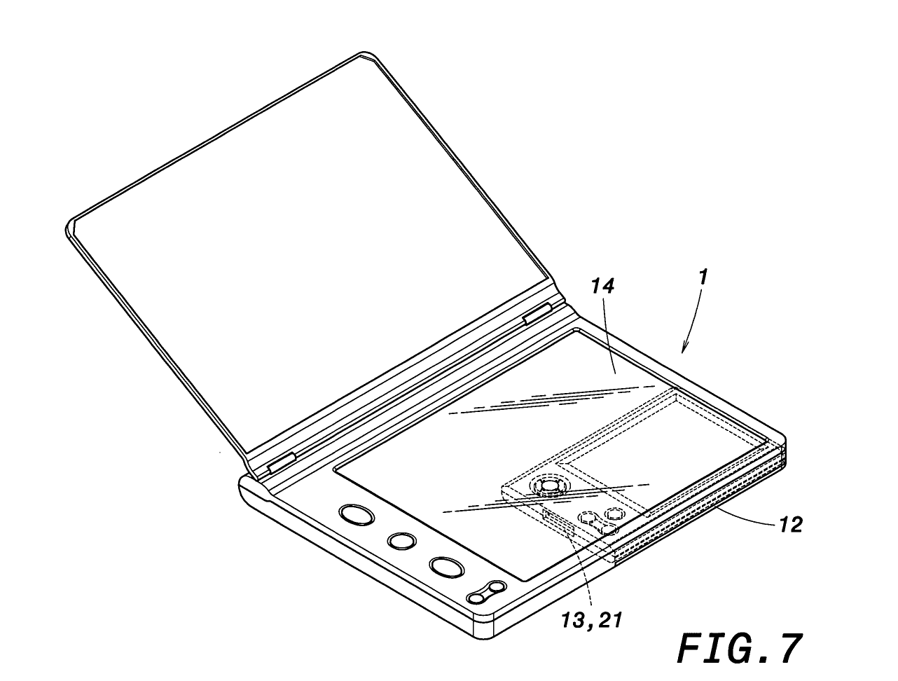

As shown in FIG. 7, the second electronic device is installed in the accommodating groove 11, and the second connection interface 21 of the second electronic device 2 and the first connection interface 13 of the first electronic device 1 are electrically connected together. A firmware capable of controlling the second electronic device 2 is stored in the first electronic device 1. When the second electronic device executes function operations, the frame data generated during the function operations will be transmitted to the display panel 14 of the first electronic device 1 for display via the first connection interface 13 and the second connection interface 21, which are electrically connected together. When a user operates, the first electronic device 1 and the second electronic device 2 can transmit data to each other to accomplish resources sharing. Frames originally displayed on the display panel 22 of the electronic device 2 can be displayed on the larger display panel 14 of the first electronic device 1 to accomplish a better browsing effect during operations.

To sum up, the combinational portable electronic device of the present invention has the following characteristics:
1. An electronic book reader (or a web-pad) and a PDA are integrated into a portable device to have simultaneously the advantages thereof.

Moreover, the cost can be effectively saved.
2. The connection method is simple and quick. A user can have greater convenience and a better browsing effect during operations.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A combinational portable electronic device comprising:
a first electronic device having a display panel, said first electronic device having an accommodating groove, a first connection interface being provided in said accommodating groove; and
a second electronic device having a display panel and a second connection interface;
whereby said second electronic device is installed in said accommodating groove of said first electronic device with said first connection interface and said second connection interface electrically connected together so that said first electronic device and said second electronic device can transmit data with each other.

2. The combinational portable electronic device as claimed in claim 1, wherein said first electronic device is an electronic book reader or a web-pad.

3. The combinational portable electronic device as claimed in claim 1, wherein said accommodating groove has a closable cover board outside.

4. The combinational portable electronic device as claimed in claim 1, wherein said second electronic device is a personal digital assistant.

5. The combinational portable electronic device as claimed in claim 1, wherein the size of said display panel of said first electronic device is larger than the size of said display panel of said second electronic device.
